(19) United States
(12) Patent Application Publication
(10) Pub. No.: US 2002/0107948 A1
(43) Pub. Date: Aug. 8, 2002

(54) Standards for performing collaborative network-based engineering design

(76) Inventors: Mohamed Ahmed Ali, Clifton Park, NY (US); Bharat Sampathkumaran Bagepalli, Niskayuna, NY (US); Michael Joseph Krok, Clifton Park, NY (US); Jeffrey LeMonds, Clifton Park, NY (US); Andrew Joseph Poslinski, West Sand Lake, NY (US); Mark Alan Preston, Niskayuna, NY (US); Brion Daryl Sarachan, Schenectady, NY (US); Gerald Gene Trantina, Ft. Myers Beach, FL (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/775,487

(22) Filed: Feb. 2, 2001

(51) Int. Cl. G06F 15/173; G06F 17/30

(52) U.S. Cl. 709/223; 707/10

(57) ABSTRACT

An exemplary embodiment of the invention is a method for a standardized collaborative engineering. The method includes representing design information in a standard transmission format at a client and uploading the design information in the standard transmission format to a server. The server receives the design information in the standard transmission format and converts the design information in the standard transmission format to design information in a product data management format. The server stores the design information in the product data management format.

### CROSS REFERENCE TO RELATED APPLICATIONS

The present application is related to copending U.S. Provisional Application Serial No. ______, entitled, “Process and Architecture for Performing Internet-Based Engineering Design”, filed on Jan. 28, 2000 in the name of Ali, et al., attorney docket no. RD-27384, and copending U.S. Provisional Application Serial No. ______ entitled, “Standards for Performing Collaborative Internet-Based Engineering Design”, filed on Jan. 28, 2000 in the name of Ali, et al., attorney docket no. RD-27383.

### BACKGROUND OF THE INVENTION

The present invention relates to a method and apparatus for local and wide area networks and, more particularly, to a method and apparatus for providing a web-enabled platform that allows users connected to the Internet to access specific information related to their participation in a group project using integrated Design For Six Sigma (DFSS) Generation-III quality tools.

The Internet is a worldwide linkage of networks designed to store information at many widely separated sites. The World Wide Web (hereinafter referred to as “WWW”) is a method of finding text, moving and still images on the Internet using hypertext links. An individual desktop computer uses browser software to communicate with a server at a remote location using telephone lines or other communication channels. Commonly used browsers include Microsoft Internet Explorer® or the Netscape Navigator®. Using the WWW permits the user to have access to complicated databases and software without having overly complex software on the individual computer. Readily available desktop computers equipped with a modem and an off the shelf operating system are capable of communicating with the WWW to send and receive information.

Currently, Web pages are typically defined using Hypertext Markup Language (hereinafter referred to as “HTML”). HTML provides a standard set of tags that define how a Web page is to be displayed. When a user indicates to the browser to display a Web page, the browser sends a request to the server computer system to transfer to the client computer system an HTML document that defines the Web page. When the request HTML document is received by the client computer system, the browser displays the Web page as defined by the HTML document. The HTML document contains various tags that control the displaying of text, graphics, controls, and other features. The HTML document may contain Uniform Resource Locators (hereinafter referred to as “URL”) of other Web pages available on that server computer system or other server computer systems.

In business, the Internet and use of e-mail are becoming the preferred modes of communication amongst employees in a corporation. With the increase in the number of employees in a corporation using a server computer system to communicate with other employees and to search for information from various electronic Web sites, an opportunity for potentially meaningful and productive work related interaction amongst employees arises.

With the advent of the Internet and worldwide marketplace as well as consumer demand for highly reliable products, quality always remains an increasingly important issue. The quality of a company's product line can therefore play a decisive role in determining the company's reputation. As a result of this pressure for defect-free products, increased emphasis is being placed on quality control at all levels; it is no longer just an issue with which quality control managers are concerned. This has led to various initiatives designed to improve quality, such as the Total Quality Management (TQM) and the Six Sigma quality analysis programs. An overview of the Six Sigma program is presented by Mikel J. Harry, Ph.D., and Richard Schroeder in “Six Sigma The Breakthrough Management Strategy Revolutionizing the World's Top Corporations”, Doubleday, pp. 1-38, 2000.

The design for six-sigma process is a disciplined process for designing products and services in which massive sets of data are exchanged. The design process can be idealized as being a sequence of events. Whenever an event takes place, it is communicated to certain individual and/or computers in the organization. This by itself will launch another activity. The completion of such an activity is again another event. This new event will restart the cycle again with another activity until the whole process is completed. Therefore, the DFSS process can be idealized as being a sequence of the event-communication-activity-event cycle, which can be thought of as the building blocks of the design process.

For any process (business, manufacturing, service, etc.), the sigma value is a metric that indicates how well the process is performing. The higher the sigma value, the better the output. Sigma measures the capability of the process to perform defect-free-work, where a defect is synonymous with customer dissatisfaction. With Six Sigma the common measurement index is defects-per-unit where a unit can be virtually anything—a component, a part of a jet engine, an administrative procedure, etc. The sigma value indicates how often defects are likely to occur. As sigma increases, customer satisfaction goes up along with improvement of other metrics (e.g., cost and cycle time).

Decisions made regarding direction, interpretation, scope, depth or any other aspect of quality effort should be based on actual data gathered, and not based on opinion, authority or guesswork. Key critical-to-quality (CTQ) characteristics are set by customers. Based on those CTQs, internal measurements and specifications are developed in order to quantify quality performance. Quality improvement programs are developed whenever there is a gap between the customer CTQs and the current performance level.

The Six Sigma methodology has been used by a number of companies such as Motorola Semiconductors, Texas Instruments, Allied Signal and Digital Corporation. All of these companies use this process for a specific application such as semiconductor manufacturing in the case of Motorola and Texas Instruments. An overview into the evolution and impact of Six Sigma is presented by Gerald J. Hahn, Necip Doganaksoy and Roger Hoerl in “The Evolution of Six Sigma”, Quality Engineering, 12(3), 000 (1999-2000).

It is therefore desirable to have an apparatus and a method for using a web-enabled platform for the efficient design of team-oriented projects requiring Design For Six Sigma quality control.

It is therefore desirable to have an apparatus and a method for enabling a design team to concurrently work in a Design For Six Sigma quality improvement program environment on a project at dispersed platform sites using a web-enabled product design advisor over a global communication network.

It is therefore desirable to have a method and an apparatus for a user, client or even a vendor, to use a web-enabled platform with specific access privileges to a design advisor that enables each user to concurrently work on designing a product within a Design For Six Sigma process using design tools, statistical analysis tools and user developed tools.

### BRIEF SUMMARY OF THE INVENTION

An exemplary embodiment of the present invention is a method for planning and performing a design of a product using a web-enabled product design advisor. Customer and vendor information pertaining to a specific product is stored in a web-enabled design advisor platform with integrated Design For Six Sigma Generation-III quality tools. One or more users at dispersed locations design the specific product based on the customer and vendor information using a selection of software tools and models in the web-enabled product design advisor. The users can track the progress of the design over a global communication network using the web enabled product design advisor. Once the design is complete, the users can then evaluate and store the design of that specific product using the web-enabled design advisor.

These and other features and advantages of the present invention will be apparent from the following brief description of the drawings, detailed description, and appended claims and drawings.

### BRIEF DESCRIPTION OF THE DRAWINGS

For a further understanding of the nature of the present invention, as well as other features and advantages thereof, reference should be made to the following detailed description taken in conjunction with the accompanying drawings, which are meant to be exemplary, not limiting, and wherein like elements are numbered alike in the several figures:

FIG. 1 illustrates a Web-Enabled Product Design Advisor in a computer system;

FIG. 2 is a pictorial representation of an exemplary Web-Enabled Product Design Advisor of FIG. 1;

FIG. 3 is a flowchart of an exemplary Design For Six Sigma quality improvement program integrated with the Web-Enabled Product Design Advisor of FIG. 1;

FIG. 4 is a block diagram of an exemplary Subsystem Concept Design and Optimization and System Modeling and Optimization taken from the Design For Six Sigma tool of FIG. 3; and

FIG. 5 is a pictorial representation of an exemplary Subsystem Concept Design taken from the Design For Six Sigma program of FIG. 3 and the Web-Enabled Product Design Advisor of FIG. 1.

### DETAILED DESCRIPTION OF THE INVENTION

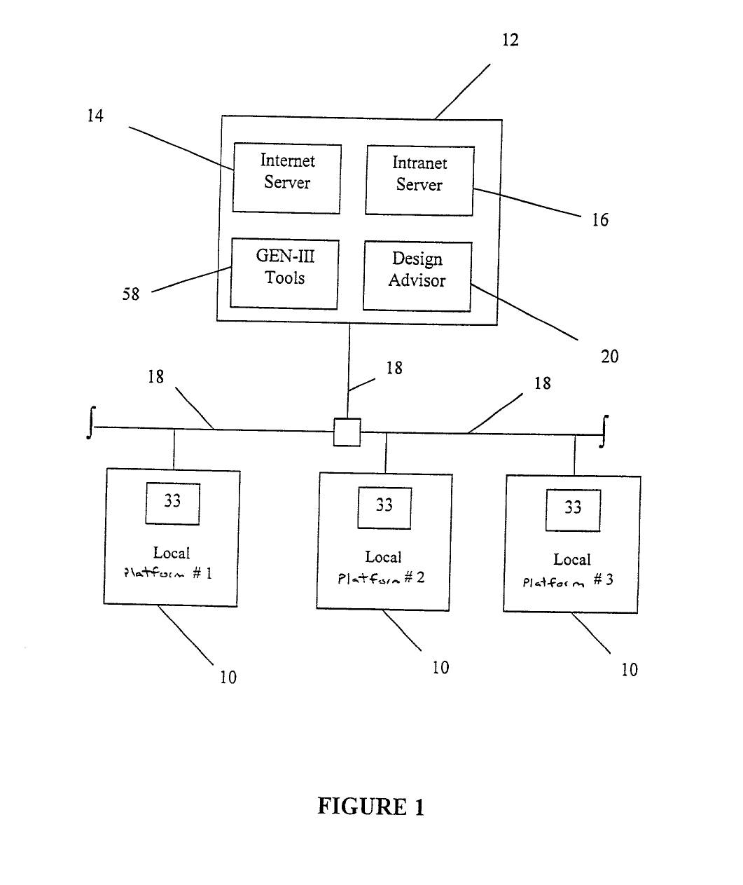

FIG. 1 illustrates a block diagram of a computer system having a plurality of various platforms 10 connected by a network to at least one central server 12. Platforms 10 may comprise platforms such as personal computers (PCs), desktop terminals, or other computers or terminals, for example. Central server 12 may comprise an Internet Server 14, a private Intranet Server 16, a data transfer connection 18, and a design advisor 20 as well as other software, hardware, peripherals, and combinations thereof, and the like. Although the Internet is referred to herein for purposes of example, the present invention is intended to encompass other mediums than the Internet—particularly in the event that another form of standardized digital communication evolves.

Platforms 10 are equipped with software that permits platforms 10 to communicate with server 12 via Internet. The platforms use readily available Internet browser software such as Microsoft Internet Explorer or Netscape Navigator and also have a microprocessor for executing common software programs used by the system and mass memory for storing data obtained from design advisor 20 as well as data generated and/or used locally. Data is shared (imported/exported) between platforms 10 and design advisor 20 via data transfer connection 18 which may be a WAN (wide area network) or LAN (local area network), an e-mail or file transfer connection, or physical exchange of data storage media, for example. Design Advisor 20 can be operated by an individual at a local site or, by several individuals or groups of persons across a network or, likewise, by several individuals or groups of persons across a global array of web-enabled platforms. Design advisor 20 is preferably written as a customized application for a conventional web-enabled platform that can run on servers, PCs, and laptops alike. Design advisor 20 allows its users to have web-enabled access to various design tools, statistical analysis tools and user developed tools.

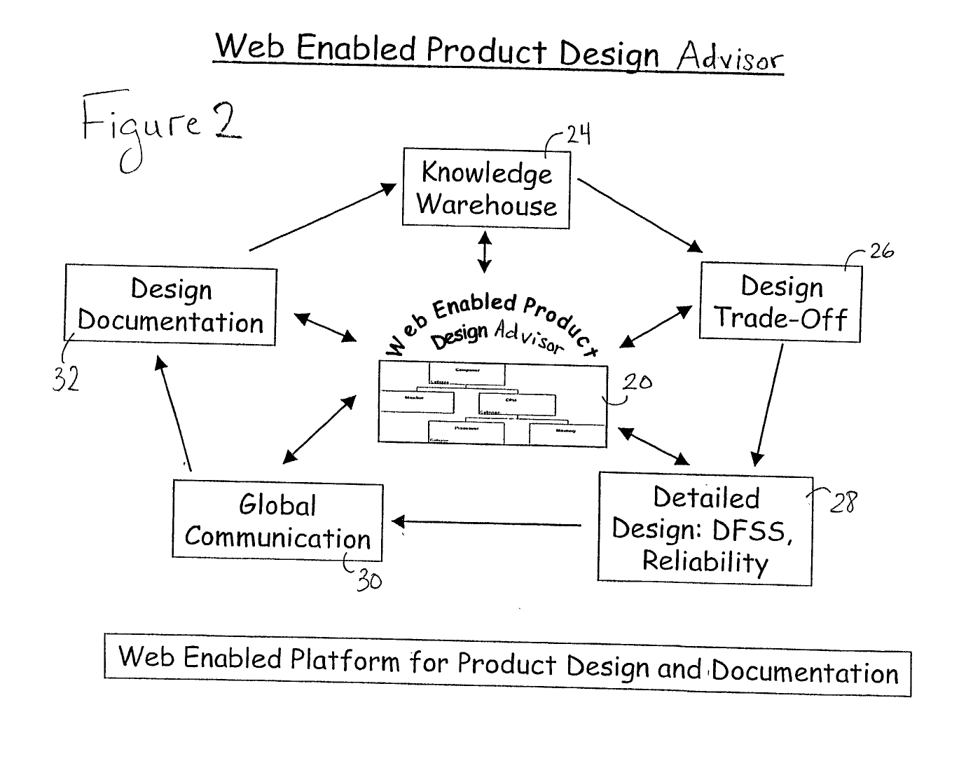

FIG. 2 depicts how design advisor 20 combines several functions including knowledge warehouse 24, design trade-off tool 26, Design For Six Sigma (DFSS) tool 28, global communication network 30, and a design documentation tool 32, that users can utilize separately or in conjunction, when working together. For example, several users can apply design advisor 20 to concurrently design a circuit breaker such as in the prospective example that follows.

Referring again to FIG. 2, Knowledge Warehouse 24 can include current, legacy and competitor's product designs, including simple and specialized tools, market data, and the like all pertaining to the current product being designed as well as other products in various stages of development, including combinations thereof, and the like. Design Trade-Off tool 26 can include different concepts for preliminary system and subsystem designs in a product's design process. Design For Six Sigma tool 28 (hereinafter referred to as “DFSS”) can manage the event-communication-activity-event cycle for the system and subsystem design process so that quality improvement program standards are continuously implemented and maintained. Global communication network 30 facilitates communication between users at remote locations throughout a global community of web-enabled platforms during the entire DFSS event-communication-activity-event cycle. Design Documentation tool 32 can include a repository of final product designs for reference. The tools of FIG. 2 are typically embodied in computer readable program codes.

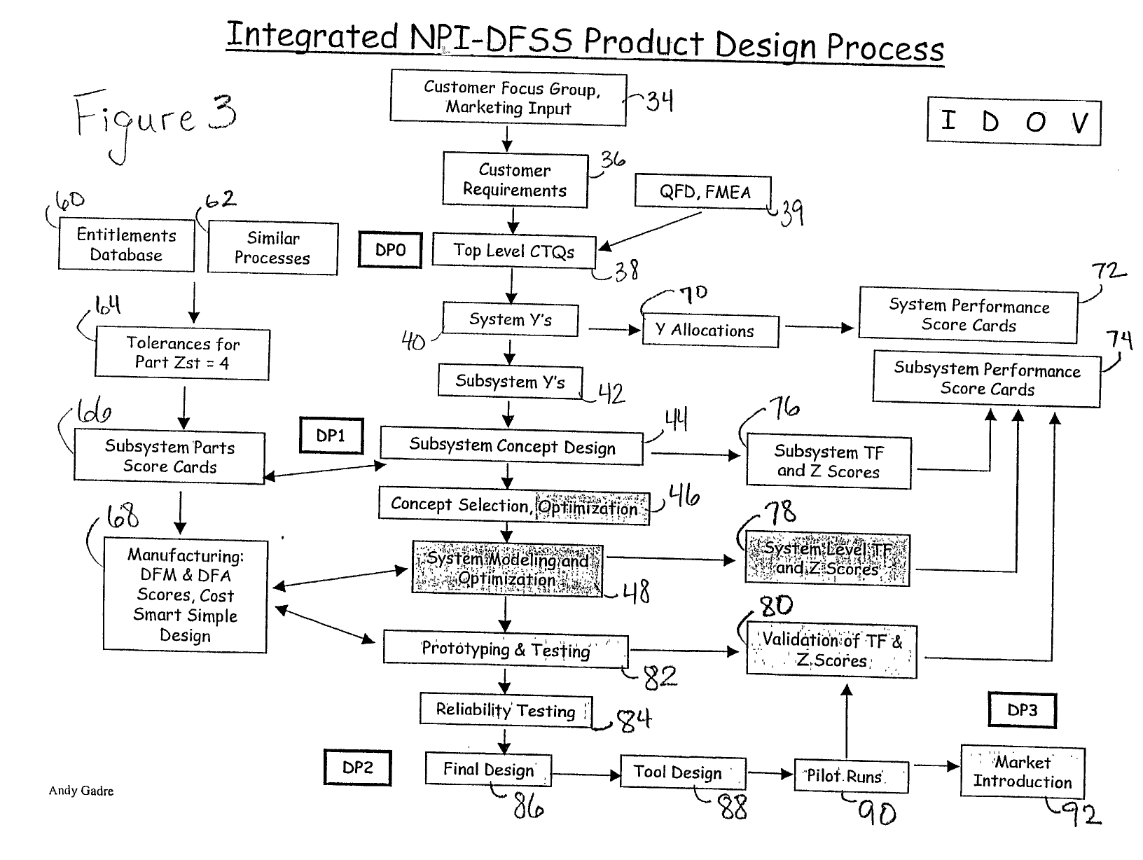

FIG. 3 illustrates a prospective example of a circuit breaker design process incorporating design advisor 20 of FIG. 1 and the DFSS tool 28 of FIG. 2. During the design process, users have specific access privileges to the latest renditions of a design in progress. A systems engineer, or any other user designated to oversee the design process, can define a user's access by using an applet 33 (FIG. 1). Applets are small computer programs written in JAVA™ programming language (JAVA is a trademark of Sun Microsystems, Inc.) using an object oriented programming (hereinafter referred to as “OOP”) approach. When a user instructs the browser to download an applet from a web page, the browser sends an instruction to the server computer to transfer the applet to the user's computer, i.e., personal computer, laptop computer, network system, and the like. The user can download applet 33 from central server 12 through data transfer connection 18 for use in his or her platform 10. The user can also download applet 33 from a web page via data transfer connection 18. The portability of JAVA programming language to various platforms (PC, UNIX, etc.) allows applets 33 to operate under different operating systems. Each step of the DFSS product design process is independent and can be executed or modified without interaction with other applications. Each step can also be saved independently and re-used and can communicate with other applications using data transfer connection 18 and Global Communication network 30 of design advisor 20 (FIG. 1).

Referring again to FIG. 3, the circuit breaker design process using design advisor 20 begins by identifying the customer's needs. A user enters Customer Focus Group and Marketing Input at a block 34 and combines this information at a block 36 with Customer Requirements. The customer focus group and marketing input information is accessed in Knowledge Warehouse 24 (FIG. 2) by using features of Global Communication network 30 (FIG. 2) in design advisor 20 (FIG. 1). Top Level CTQs are determined and identified at a block 38 using Marketing Input from block 34 and Customer Requirements from block 36.

Top Level CTQs are key Critical-To-Quality characteristics set by customers. Based on those CTQs, internal measurements and specifications are developed in order to quantify quality performance. Quality improvement programs are developed whenever there is a gap between the customer CTQs and the current performance level. The basic steps in a quality improvement program are first to define the real problem by identifying the CTQs and related measurable performance that is not meeting customer expectations. CTQs are further defined by applying both Quality Function Deployment (hereinafter referred to as “QFD”) and Failure Mode Effect Analysis (hereinafter referred to as “FMEA”) at a block 39 (FIG. 3). QFD is a system for translating consumer requirements into appropriate company requirements at each stage from Research and Product Development to Engineering and Manufacturing to Marketing/Sales and Distribution. FMEA is a disciplined approach for identifying and classifying the type, severity and detectability of all modes of failure of a product or process. FMEA can be and is preferably implemented throughout the DFSS event-communication-activity-event cycle. An overview of the Six Sigma program is presented by Mario Perez-Wilson in “Six Sigma—Understanding the Concept, Implications and Challenges”, Mario Perez-Wilson, 1999.

Once Top Level CTQs are finalized at block 38, System Y's or external customer requirements (Y) pertaining to the entire system being designed are determined at a block 40. System Y's relate customer Top Level CTQs to quantifiable quantities. Subsystem Y's break down the System Y values for the entire product. Subsystem Y's are determined at a block 42. After determining the external customer requirements, the design team can then design the product according to the System and Subsystem Y's (FIG. 3). All Y's are compilated in Y Allocations at a block 70 and recorded in the System Performance Score Card at a block 72 and Subsystem Performance Score Card at a block 74, respectively.

Design Trade-Off tool 26 (FIG. 2) can be utilized by and between users using Global Communication network 30 of design advisor 20 at a block 44 for Subsystem Concept Design, at a block 46 for Concept Selection and Optimization, and at a block 48 for System Modeling and Optimization in the DFSS product design process.

To allow for communication with a variety of tools, each application has a translator that allows it to communicate and execute various external tools (commercial applications such as ANSYS Inc. finite element tools, SABER® simulation tools available from Analogy, Inc., Microsoft EXCEL® spreadsheets, etc.). The translator provides a standard communications interface to the application that enables other components of the system to access functions of that particular application in a standardized manner. In addition, the JAVA programming language and platform can be used to implement each application. The OOP approach used in JAVA programming language allows for easy implementation of the DFSS process.

The portability of JAVA programming language to various platforms (PC, UNIX. etc.) allows the software to operate under different operating systems. The whole process is modeled in the form of an OOP data structure for easy implementation. A graphical user interface (GUI) is also implemented in the JAVA programming language in order to allow each application to communicate with other tools such as engineering tools and statistical tools. Communication with Microsoft object linking and embedding (OLE) and with dynamic data exchange (DDE) is provided via the JAVA programming language to OLE and DDE servers. The system includes an open architecture allowing users to write their own translators. Thus, other communications methods (other than OLE, etc.) can be supported by the system.

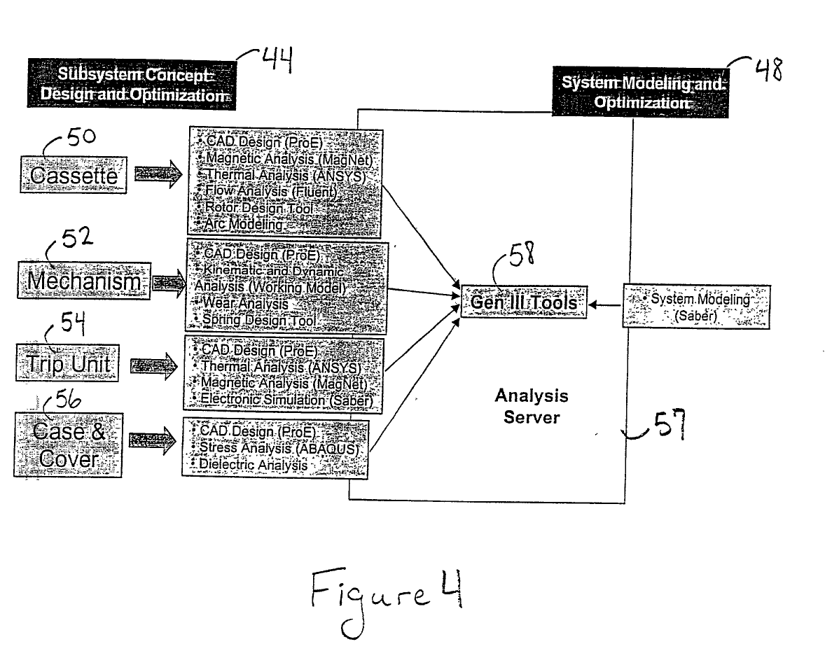

Using design advisor 20, users can access design tools, statistical analysis tools, and user developed tools, as well as other computer software commonly used during a design process, and the like, to design a product. Referring now to a prospective example in FIG. 4, Subsystem Concept Design at block 44 may comprise a Cassette subsystem 50, Mechanism subsystem 52, Trip Unit subsystem 54 and Case & Cover subsystem 56 when designing, for instance, a circuit breaker.

Referring again to FIG. 3, once the design models (system, subsystem, component, and or business models) are generated, this information is compiled and forwarded to Subsystem TF and Z scores at a block 76. DFSS tool 28 compiles and evaluates design information as TF and Z scores to ensure the highest quality standards are maintained throughout the design process. Various Subsystem Concept Designs are related and refined to dimensions and quantities, i.e., pertaining to individual components of each subsystem at Concept Selection, Optimization at block 46. Design advisor 20 permits users to communicate any and all changes in a current product design to each other via Global Communication network 30.

As specific parts and components of the subsystems are conceptualized and selected, the parts are compared to a scorecard assembled at the start of the DFSS product design process. The Entitlements Database at a block 60 and Similar Processes at a block 62 can provide useful information for relating and refining dimensions and quantities for each part of each subsystem. Entitlements database can provide information, including standard deviations, for manufacturing each individual part and component of each subsystem. Similar processes can comprise a repository of processes that relate to each part of component. The user can find a related process to the part's intended use in the new product. The tolerances specified for each part, keeping in mind its intended function, are enumerated to four sigma (4 σ) at a block 64.

The information compiled at blocks 60, 62, and 64 is placed in the Subsystem Parts Score Cards at a block 66. A specific user or group of users can then simultaneously implement DFM (Design For Manufacturability) and DFA (Design For Assembly tools to ensure the current Subsystem Concept Designs meet feasible manufacturability requirements for each part and/or component in the design. After System Modeling and Optimizing at block 48 is complete, these DFM and DFA scores will then be compared to the Score Cards at block 68. Although a value recorded at block 66 for a conceptualized part may indicate it is feasible to manufacture, the DFM and DFA scores will indicate whether the component's design is feasible or if the component can be further simplified. Once the System Modeling and Optimizing information is compared to DFM and DFA values, the information can then be forwarded to Validation of TF and Z scores at a block 78 for further review.

Referring again to the prospective example in FIG. 4, Generation-III quality tools 58 can combine all of the tools, including the following tools for example, for designing a circuit breaker: mechanism analysis tools, thermal analysis tools, electromagnetic analysis tools, structural analysis tools, and custom arc physics tools, and combinations thereof and the like. Generation-III quality tools 58 optimize all of the design tools, statistical analysis tools and user-developed tools at subsystem and system levels.

Generation-III quality tools 58 incorporate analysis server 57 in order to accomplish optimization. Analysis server 57 can also include common engineering tools such as ANSYS finite element tools, Minitab, Inc. statistical software, and SABER simulation tools, as well as statistical tools and methods such as Quality Function Deployment, Failure Mode and Effect Analysis, Design of Experiments, Monte Carlo and many other tools. For example, analysis server 57 utilizes SABER simulation tools to compile and relate all of the subsystem information together in System Modeling and Optimization at block 48. Each application also includes an automatic experimentation capability that allows the user to enter data in either manual mode or an automatic mode. The automatic mode allows for easy integration of various engineering tools and also allows the user to automate repetitive processes and tasks. Analysis server 57 ties in all of the above-mentioned tools together.

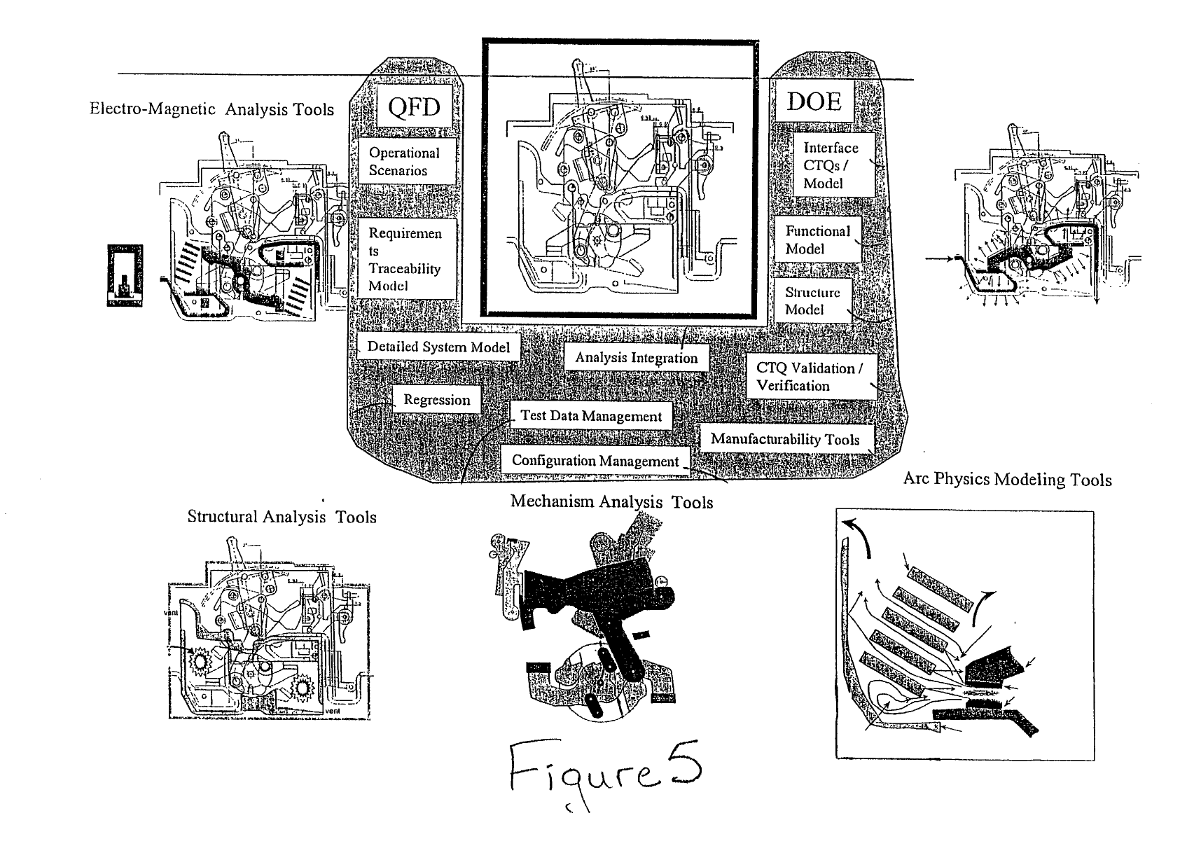

Referring now to a prospective example in FIG. 5, the specific analysis tools mentioned above are pictorially represented as images on a computer screen. For example, such a screen image can be displayed for use on platform 10 so that a user or users can perform certain analyses and operations using the analysis tools mentioned above. Mechanism analysis tools, electromagnetic analysis tools and flow analysis tools include simple tools to perform trade-off studies and more involved tools to perform detailed design, modeling and analysis, including combinations thereof, and the like. Thermal and structural analysis tools include simple tools to perform trade-off studies and more involved tools to perform detailed design, modeling and analysis of metal and non-metal components, including combinations thereof, and the like. Custom arc physics tools facilitate modeling interrupters, arc chambers, including combinations thereof, and the like.

Referring again to FIG. 4, both Quality Function Deployment (hereinafter referred to as “QFD”) and Design of Experiments (hereinafter referred to as “DOE”) are implemented while designing the circuit breaker at block 44 and block 48. DOE is a process using planning and statistical tools for gathering the maximum amount of useful information from an experimental program. DOE can also access Generation-III quality tools 58 via Global Communication tool 30 of design advisor 20. Since design advisor 20 provides a generic platform for implementing a DFSS quality improvement program, quality tools 58 can be customized for a particular user. For example, DOE can be enhanced by allowing access to custom designs generated by a particular user. Additional advantages of the DOE include access to a Microsoft Access® database (including 300+ experimental designs) and designs for a large number of parameters. Moreover, the database provides access to special purpose designs such as mixed level and optimal designs.

In this prospective example, QFD and DOE can include tools such as Operational Scenarios, Requirements Traceability Model, Detailed System Model, Regression Analysis, Analysis Integration, Test Data Management, Configuration Management, Manufacturability Tools, CTQ Validation/Verification, Structure Model, Functional Model and Interface CTQs/Model as well as other design tools, statistical analysis tools and user developed tools, including combinations thereof, and the like.

Referring again to FIG. 3, once the users have completed their initial design of a circuit breaker, the design undergoes prototyping and testing at a block 82. A specified user or group of users can communicate any and all changes during the prototyping and testing of the new product utilizing Global Communication network 30 of design advisor 20 (FIG. 1). Once completed the TF and Z scores are validated at a block 80. These scores are then forwarded to the Subsystem Performance Score Cards at block 74 for further review. From block 82, the product design undergoes further reliability testing at a block 84 to meet the Top Level CTQs determined at block 38. Again, Design advisor 20 provides the users an opportunity to communicate their ideas and corresponding results using Global Communication network 30. After a final design is approved at a block 86, the users can utilize design advisor 20 to compile all the data gathered and generate the necessary tools for manufacturing the final product at a block 88. The final product can then undergo Pilot Runs at a block 90. The information gathered from the Pilot Runs is forwarded to block 80 for validation and, then, to block 74 for further review. The intended product's market introduction is the final step at a block 92 in this exemplary of the DFSS product design process.

At design blocks such as subsystem concept design 44, system modeling and optimization block 48, and final design block 86, for example, additional optional functions can be performed, as appropriate or desired. For example, in one embodiment, product design includes executing at least one of a plurality of chained analysis codes. In another additional or alternative embodiment, product design includes using the web-based design advisor to interface with a plurality of field and test data or to access and use a plurality of manufacturability databases.

An advantage provided by the web-enabled product design advisor is that it allows an entire design team to work together at remote locations across a global network thereby eliminating the logistics of bringing that same team together to a central location.

Another distinct advantage is that users can access a repository of legacy product designs including systems, subsystems and components as well as simple analysis modules via the web-enabled product design advisor.

Another advantage is that trade-off and optimization tools can be incorporated into the web-enabled product design advisor platform as well. Design team members can access a repository of legacy product designs including systems, subsystems and components as well as simple analysis modules.

Yet another advantage is that the web-enabled product design advisor can be used for specific product design as opposed to a simple database and communication tool.

Another significant advantage is that throughout the design process a Design For Six Sigma quality improvement program is incorporated so that the highest quality product is developed.

Another advantage is that each tool may be used in conjunction with Generation-III quality tools throughout the design process a circuit breaker, or any other product design.

Another recognized advantage is that test data can not only be shared but also applied to the instant application being designed by design team members at dispersed platform locations across a global network. Manufacturability and Producibility databases, and combinations thereof and the like, may be accessed as well as current information on Customers, Vendors and the associated quality of supplied parts.

Another important advantage is that Generation-III quality tools may be used in cooperation and conjunction with the web-enabled design advisor using various platforms. Since a common program adaptable to various platforms may be used, all sites can send/receive and maintain their project information in a common format and with complete file compatibility with the vendor's or customer's central server and with all other project sites. This provides a central functionality to the system to manage projects of a similar type. Information on best current practices and lessons learned can be gathered (exported) dynamically at the central server from all local projects of a similar type, and then shared among all local projects (imported).

Yet another advantage is that a design team member, vendor and/or customer can have access privileges to the web-enabled product design advisor at remote platforms to maximize the potential overall quality of the final product.

The present invention can be embodied in the form of computer-implemented processes and apparatuses for practicing those processes. The present invention can also be embodied in the form of computer program code including instructions, embodied in tangible media, such as floppy diskettes, CD-ROMs, hard drives, or any other computer-readable storage medium, wherein, when the computer program code loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When the implementation on a general-purpose microprocessor, the computer program code segments configure the microprocessor to create specific logic circuits.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method for a standardized collaborative engineering comprising:
representing design information in a standard transmission format at a client;
uploading said design information in said standard transmission format to a server;
receiving said design information in said standard transmission format at said server;
converting said design information in said standard transmission format to design information in a product data management format; and
storing said design information in said product data management format.

2. The method of claim 1 further comprising:
receiving at said server a request for design information from said client;
converting design information in said product data management format to design information in said standard transmission format; and
downloading said design information in said standard transmission format to said client.

3. The method of claim 1 wherein said standard transmission format includes a format for CTQs.

4. The method of claim 1 wherein said standard transmission format includes a format for design parameters.

5. The method of claim 1 wherein said standard transmission format includes a format for transfer functions.

6. The method of claim 1 wherein said standard transmission format includes a format for product structure.

7. The method of claim 1 wherein said standard transmission format includes a format for constraints.

8. The method of claim 1 wherein said standard transmission format is based on XML.

9. The method of claim 1 wherein said standard transmission format includes instructions for executing a transfer function.

10. The method of claim 1 wherein said product data management format includes a hierarchy of classes of objects including CTQs, design parameters, transfer functions, product structure, and constraints.

11. The method of claim 1 wherein said uploading utilizes HTTP protocol.

12. The method of claim 2 wherein said downloading utilizes HTTP protocol.

13. A system for standardized collaborative engineering comprising:
a client for representing design information in a standard transmission format;
a server coupled to said client via a network, said client uploading said design information in said standard transmission format to the server;
said server receiving said design information in said standard transmission format and converting said design information in said standard transmission format to design information in a product data management format; and
said server storing said design information in said product data management format.

14. The system of claim 13 wherein:
said server receives a request for design information from said client, converts design information in said product data management format to design information in said standard transmission format; and downloads said design information in said standard transmission format to said client.

15. The system of claim 13 wherein said standard transmission format includes a format for CTQs.

16. The system of claim 13 wherein said standard transmission format includes a format for design parameters.

17. The system of claim 13 wherein said standard transmission format includes a format for transfer functions.

18. The system of claim 13 wherein said standard transmission format includes a format for product structure.

19. The system of claim 13 wherein said standard transmission format includes a format for constraints.

20. The system of claim 13 wherein said standard transmission format is based on XML.

21. The system of claim 13 wherein said standard transmission format includes instructions for executing a transfer function.

22. The system of claim 13 wherein said product data management format includes a hierarchy of classes of objects including CTQs, design parameters, transfer functions, product structure, and constraints.

23. The system of claim 13 wherein said uploading utilizes HTTP protocol.

24. The system of claim 14 wherein said downloading utilizes HTTP protocol.

25. A storage medium encoded with machine-readable computer program code for standardized collaborative engineering between a server and a client coupled to a network, the storage medium including instructions for causing the server to implement a method comprising:
uploading design information in a standard transmission format to the server;
converting said design information in said standard transmission format to design information in a product data management format; and
storing said design information in said product data management format.

26. The storage medium of claim 25 further comprising instructions for causing the server to implement:
receiving a request for design information from said client;
converting design information in said product data management format to design information in said standard transmission format; and
downloading said design information in said standard transmission format to said client.

27. The storage medium of claim 25 wherein said standard transmission format includes a format for CTQs.

28. The storage medium of claim 25 wherein said standard transmission format includes a format for design parameters.

29. The storage medium of claim 25 wherein said standard transmission format includes a format for transfer functions.

30. The storage medium of claim 25 wherein said standard transmission format includes a format for product structure.

31. The storage medium of claim 25 wherein said standard transmission format includes a format for constraints.

32. The storage medium of claim 25 wherein said standard transmission format is based on XML.

33. The storage medium of claim 25 wherein said standard transmission format includes instructions for executing a transfer function.

34. The storage medium of claim 25 wherein said product data management format includes a hierarchy of classes of objects including CTQs, design parameters, transfer functions, product structure, and constraints.

35. The storage medium of claim 25 wherein said uploading utilizes HTTP protocol.

36. The storage medium of claim 26 wherein said downloading utilizes HTTP protocol.
